(19) United States
(12) Patent Application Publication
(10) Pub. No.: US 2025/0182313 A1
(43) Pub. Date: Jun. 5, 2025

(54) SYSTEM AND METHOD FOR EYE-GAZE BASED DATA LABELING

(71) Applicant: GM GLOBAL TECHNOLOGY OPERATIONS LLC, Detroit, MI (US)

(72) Inventors: Ron M. Hecht, Raanana (IL); Dan Levi, Ganei Tikvah (IL); Shaul Oron, Rehovot (IL); Omer Tsimhoni, Bloomfield Hills, MI (US); Andrea Forgacs, Kfar Sava (IL); Gershon Celniker, Netanya (IL); Ohad Rahamim, Netanya (IL)

(73) Assignee: GM GLOBAL TECHNOLOGY OPERATIONS LLC, Detroit, MI (US)

(21) Appl. No.: 18/526,007

(22) Filed: Dec. 1, 2023

(51) Int. Cl. G06T 7/70; G06V 20/58; G06V 20/70

(52) U.S. Cl. CPC G06T 7/70; G06V 20/58; G06V 20/70; G06T 2207/30252

(57) ABSTRACT

A method of analyzing includes obtaining a dataset having images of an area surrounding a vehicle and identifying at least one object in each image of the images. Eye-gaze information directed to an operator of the vehicle is obtained from an eye-gaze monitoring system. The eye-gaze information includes an eye-gaze direction of the operator corresponding to each of the images. A subset of images from the images is identified for performing additional data labeling based on a relationship between the eye-gaze direction to the at least one object identified in each image of the images.

### INTRODUCTION

Vehicles are a staple of everyday life. Special use cameras, microcontrollers, laser technologies, and sensors may be used in many different applications in a vehicle. Cameras, microcontrollers, and sensors may be utilized in enhancing automated structures that offer state-of-the-art experience and services to the customers, for example in tasks such as body control, camera vision, information display, security, autonomous controls, etc. Vehicular vision systems may also be used to assist in vehicle control.

Vehicular vision systems may be used to provide the vehicle operator with information of the environment surrounding the vehicle. The vision systems may also be used to greatly reduce blind spot areas to the sides and rear of the vehicle. Vision systems may also be used to monitor the actions and movements of occupants, especially the vehicle operator. In particular, Driver Monitoring Systems (DMS) may include vision systems that may be used to track a vehicle operator's head and eye position and movement, e.g., eye gaze. Eye gaze may generally refer to the direction that a driver's eyes are fixated at any given instant. Such systems may detect an operator eye gaze and may be used in numerous useful applications including detecting driver distraction, drowsiness, situational awareness, and readiness to assume vehicle control from an automated driving mode for example.

### SUMMARY

Disclosed herein is a method of analyzing an image dataset. The method includes obtaining a dataset having images of an area surrounding a vehicle and identifying at least one object in each image of the images. Eye-gaze information directed to an operator of the vehicle is obtained from an eye-gaze monitoring system. The eye-gaze information includes an eye-gaze direction of the operator corresponding to each of the images. A subset of images from the images is identified for performing additional data labeling based on a relationship between the eye-gaze direction and a position the at least one object identified in each image of the images.

Another aspect of the disclosure may be where the images are obtained from at least one optical sensor on the vehicle when the vehicle is operated in a non-autonomous mode.

Another aspect of the disclosure may be where the relationship between the eye-gaze direction and the position of the at least one object is based on a proximity of a projection of the eye-gaze direction relative to the position of the at least one object.

Another aspect of the disclosure may be where a selected image from the images is included in the subset of images by determining if the proximity of the projection of the eye-gaze direction relative to the position of the at least one object includes the projection of the eye-gaze direction intersecting the at least one object.

Another aspect of the disclosure may be where a selected image from the images is included in the subset of images by determining if the proximity of the projection of the eye-gaze direction relative to the position of the at least one object is within a predetermined range.

Another aspect of the disclosure may include determining if the proximity of the projection of the eye-gaze direction relative to the position the at least one object is within a predetermined range includes determining if the projection of the eye-gaze direction is within a predetermined angular range of the at least one object.

Another aspect of the disclosure may be where the at least one object includes multiple objects and a selected image from the images is included in the subset of images by determining if the projection of the eye-gaze direction intersects at least one of the objects.

Another aspect of the disclosure may be where the at least one object includes multiple objects and a selected image from the images is included in the subset of images by determining if the projection of the eye-gaze direction is within a predetermined angular range of at least one of the objects.

Another aspect of the disclosure may be where determining if the proximity of the projection of the eye-gaze direction relative to the position of the at least one object is within the predetermined range includes determining if the projection of the eye-gaze direction intersected the at least one object for a predetermined length of time.

Another aspect of the disclosure may be where determining if the proximity of the projection of the eye-gaze direction relative to the position of the at least one object is within the predetermined range includes determining a frequency that the projection of the eye-gaze direction intersected the at least one object.

Another aspect of the disclosure may be where the at least one object is offset by a predetermined angular range from a heading of the vehicle and the at least one object includes a speed within a predetermined range.

Another aspect of the disclosure may be where the at least one object in the subset of images includes a heading in a direction transverse to a heading of the vehicle.

Disclosed herein is a non-transitory computer-readable storage medium embodying programmed instructions which, when executed by a processor, are operable for performing a method. The method includes obtaining a dataset having images of an area surrounding a vehicle and identifying at least one object in each image of the images. Eye-gaze information directed to an operator of the vehicle is obtained from an eye-gaze monitoring system. The eye-gaze information includes an eye-gaze direction of the operator corresponding to each of the images. A subset of images from the images is identified for performing additional data labeling based on a relationship between the eye-gaze direction to the at least one object identified in each image of the images.

Disclosed herein is a vehicle system. The vehicle system includes at least one optical sensor configured to capture images, at least one distance sensor configured to measure distances from the at least one distance sensor, and an eye-gaze monitoring system configured to determine a gaze direction of a driver. The vehicle system also includes a controller in communication with the at least one optical sensor, the at least one distance sensor, and the eye-gaze monitoring system. The controller is configured to obtain a dataset having images of an area surrounding a vehicle. Identify at least one object in each image of the images. Obtain eye-gaze information directed to an operator of the vehicle from an eye-gaze monitoring system. The eye-gaze information includes an eye-gaze direction of the operator corresponding to each of the images. The controller is also configured to identify a subset of images from the images for performing additional data labeling based on a relationship of the eye-gaze direction to the at least one object identified in each image of the images.

### BRIEF DESCRIPTION OF THE DRAWINGS

FIG. 1 illustrates an example vehicle system incorporating a plurality of sensors.

FIG. 2 illustrates a method of utilizing eye-gaze information for performing data labeling of images.

FIG. 3 illustrates an image of a scene surrounding the vehicle of FIG. 1 having multiple identified objects highlighted in the image along with a heading of the vehicle and a projection of an eye-gaze direction of an operator of the vehicle overlaid onto the image.

FIG. 4 illustrates an overhead schematic view of an area surrounding the vehicle of FIG. 1 with a heading of the vehicle and a projection of an eye-gaze direction of an operator of the vehicle overlaid onto the schematic.

FIG. 5 illustrates another overhead schematic view of an area surrounding the vehicle of FIG. 1 with a heading of the vehicle and a projection of an eye-gaze direction of an operator of the vehicle overlaid onto the schematic.

Some embodiments of the present disclosure are now described, by way of example only, and with reference to the accompanying drawings. The same reference number represents the same element or the same type of element on each of the drawings.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

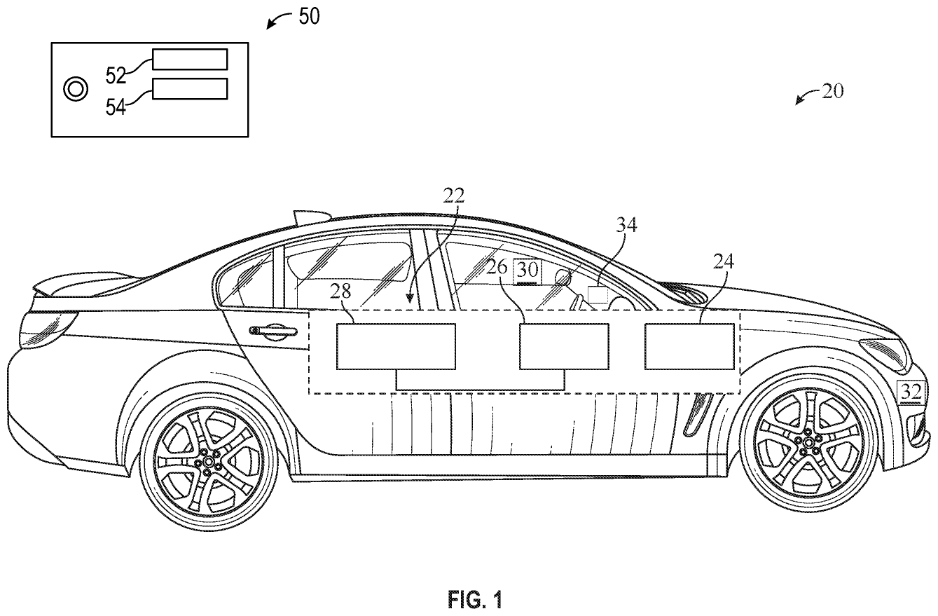

In accordance with an exemplary embodiment, FIG. 1 shows a vehicle 20 that can be operated in an autonomous mode or automated mode. The vehicle 20 can be a fully autonomous vehicle or a semi-autonomous vehicle. The vehicle 20 includes a driving system 22 that controls autonomous operation of the vehicle. The driving system 22 includes a sensor system 24 for obtaining information about the surrounding or environment of the vehicle 20, and a controller 26 for computing possible actions for the autonomous vehicle based on the obtained information and for implementing one or more of the possible actions, and a human machine interface 28 for communicating with an occupant of the vehicle, such as a driver or passenger. The sensor system 24 can include at least one optical sensor 30, such as at least one camera, at least one distance sensor 32, such as a depth camera (RGB-D) or Lidar, and an eye-gaze monitoring system 34. In the illustrated example, the optical sensor 30 and the distance sensor 32 include at least partially overlapping fields of view in order to relate information captured by each of the sensors.

The controller 26 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 26 may include a non-transitory computer-readable medium that stores instructions which, when processed by one or more processors of the controller 26, implement a method 100 of identifying a subset of images for additional data labeling.

During operation of the vehicle 20, the at least one optical sensor 30 can capture large quantities of images depending on the length of operation time spent capturing images. This can result in a dataset having tens of thousands of images that may need to be manually labeled to identify objects for training a neural network for object detection as part of operating in an autonomous or semi-autonomous mode. However, labeling each of the images in the image dataset is very labor intensive and may include images that have little training value.

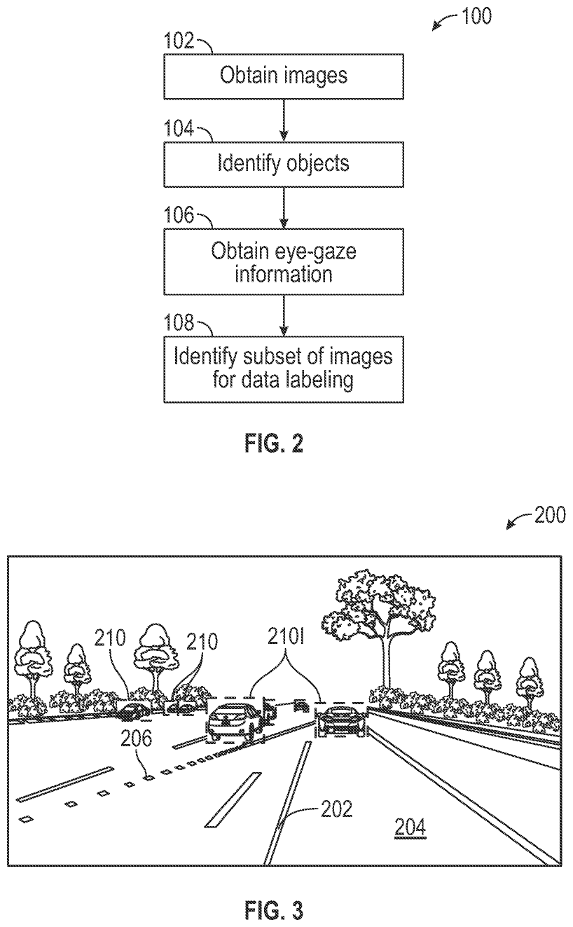

FIG. 2 illustrates an example method 100 of analyzing an image dataset that identifies subsets of images from the image dataset for performing additional data labeling. The method 100 begins at Block 102 with obtaining images of an area surrounding the vehicle 20. In one example, the images are captured by the at least one optical sensor when the vehicle 20 is being driven manually by the operator in a non-autonomous mode. While the vehicle 20 is being operated in the non-autonomous mode, the operator of the vehicle 20 remains engaged surveying an area surrounding the vehicle 20 by exhibiting changes in eye-gaze direction.

The images, such as the image 200 shown in FIG. 3, can be captured by the at least one optical sensor 30 and include a time stamp for associating with a corresponding eye-gaze direction as discussed in greater detail below. In one example, the images include a field of view in front of the vehicle 20. In another example, additional optical sensors 30 can be utilized to form an image having a field of view that surrounds the entire vehicle 20.

At Block 104, the method 100 performs an initial object detection on the images captured by the optical sensor 30 to identify objects 210, such as vehicles, traveling along a roadway 204 or adjacent to it. When performing object detection, the method 100 can utilize information from the at least one distance sensor 32 to aid in identifying the objects 210 in the images 200. The object detection performed at Block 104 can be performed by an object detector trained on a limited amount of data, which can result in a higher identification of false objects or scenes capturing rare or unique events. However, as discussed further below, eye-gaze information is utilized to reduce the number of false objects detected or false, rare, or unique scenes selected.

The object detection can be performed by the controller 26 on the vehicle 20 or by a remote computer system 50 as shown in FIG. 1. While the computer system 50 of FIG. 1 is depicted as a unitary computer module for illustrative simplicity, the computer system 50 can be physically embodied as one or more processing nodes having a non-transitory computer-readable storage medium 54, i.e., application-sufficient memory, and associated hardware and software, such as but not limited to a high-speed clock, timer, input/output circuitry, buffer circuitry, and the like. The computer-readable storage medium 54 may include enough read only memory, for instance magnetic or optical memory. Computer-readable code or instructions embodying the methods described below may be executed during operation of the computer system 50. To that end, the computer system 50 may encompass one or more processors 52, e.g., logic circuits, application-specific integrated circuits (ASICs), central processing units, microprocessors, and/or other requisite hardware as needed to provide the programmed functionality described herein.

While the optical sensor 30 obtains images from the area surrounding the vehicle 20, the eye-gaze monitor system 34 collects the eye-gaze information from the operator of the vehicle 20 at Block 106. The eye-gaze information can include an eye-gaze direction of the operator of the vehicle 20 with a time stamp for associating the eye-gaze direction with a corresponding one of the images obtained in Block 102.

As shown in FIG. 3, an eye-gaze direction 206 from the operator of the vehicle 20 as well as the heading 202 of the vehicle 20 can be overlaid onto a corresponding image 200 captured by the optical sensor 30. Furthermore, the eye-gaze monitoring system 34 can capture eye-gaze directions 206 at a rate faster than the at least one optical sensor 30 captures images. This allows each image to include more than one eye-gaze direction 206 to show changes in eye-gaze direction by the operator in a given image.

At Block 108, the method 100 identifies a subset of images from the image dataset for performing additional data labeling, such as manually performed data labeling, to identify specific objects 210 in the images 200. The additional data labeling can include applying bounding boxes that more closely surround the identified objects 210 or even identifying objects that were not detected by the limited object detection performed at Block 104. The method 100 identifies the subset of images as explained below because the subset of images have a greater training value for training a neural network through selecting images for performing the additional data labeling based on the eye-gaze information.

Also, reducing the number of images in the subset of images as compared to the larger image dataset decreases the labor needed for performing the additional data labeling on a much larger set of images. In particular, the subset of images can capture rare or unique scenes showing the objects 210 positioned around the vehicle 20 that could benefit from additional data labeling and provide valuable training information for the neural network. While simply labeling the entire image dataset would capture all the unique or rare scenes therein, this would provide minimal additional training value for the neural network when compared to extracting the rare or unique scenes from the image dataset and performing the additional data labeling on those scenes.

In the illustrated example, images are selected from the image dataset to form the subset of images based on a relationship between the eye-gaze information and the objects 210 identified in the images 200. In particular, the method 100 identifies the subset of images by analyzing a proximity of a projection of the eye-gaze direction 206 from the eye-gaze information from Block 106 with the objects 210 identified in each of the images from Block 104.

As shown in FIG. 3, there are several objects 210 or vehicles identified on the left side of the image 200 approaching the vehicle 20 in opposing traffic. The method 100 can determine that these objects 210 are of less importance than objects of interest 210I located within a predetermined proximity of the eye-gaze direction 206. The objects of interest 210I located within the predetermined proximity of the eye-gaze direction 206 can then receive additional data labeling while the remaining objects 210 in the image 200 can be disregarded for the additional data labeling. This reduces the total number of objects in an image that need to be labeled.

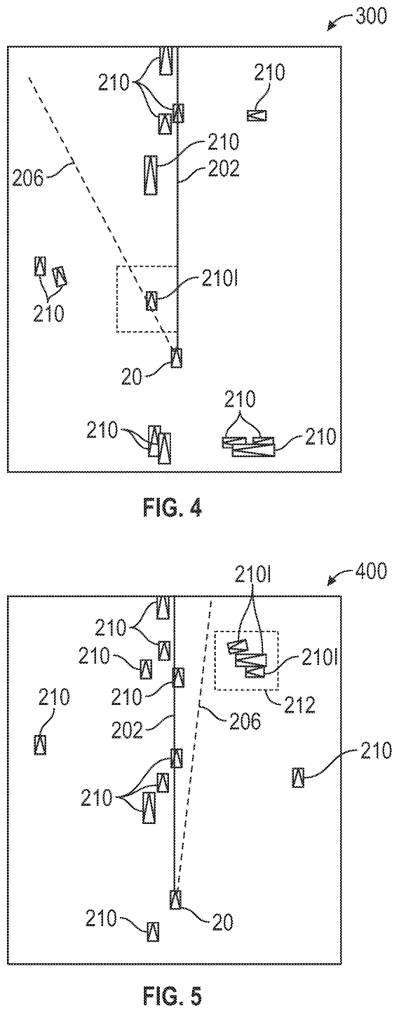

FIG. 4 illustrates an overhead schematic view 300 of an area surrounding the vehicle 20. The view 300 could be determined from images captured by the at least one optical sensor 30 or the at least one distance sensor 32. In one example, the predetermined proximity for the projection of the eye-gaze direction 206 for identifying objects of interest includes a range of angles for the projection of the eye-gaze direction 206 that intersect the object. In the schematic view 300, the heading 202 and eye-gaze direction 206 are shown projecting from the vehicle 20 and the eye-gaze direction 206 intersects an object to create an object of interest 210I. For training purposes, this can indicate that the object of interest 210I could include a behavior that makes the scene rare or unique that is capturing the attention of the operator. Therefore, the image associated with this view should be selected for the subset of images and receive additional data labeling. The additional data labeling in this example can include labeling the entire image or just labeling for the object of interest 210I in the image.

The method 100 may also identify objects of interest 210I even if the projection of the eye-gaze direction 206 does not intersect one of the objects 210. For example, one of the objects 210 can become an object of interest if the object is within a predetermined angular range of the projection of the eye-gaze direction 206. In one example, the angular range can include the projection of the eye-gaze direction 206 to be within five degrees of intersecting the object 210. In another example, the angular range can include the projection of the eye-gaze direction to be within ten degrees of intersecting the object 210. If one of the objects 210 is outside of the predetermined range, but the projection of the eye-gaze direction 206 remains within a larger predetermined angular range for a predetermined length of time, then that object can also become an object of interest and be included in the subset of images. The method 100 can also consider a frequency with which the projection of the eye-gaze direction 206 intersected or came within the predetermined range of the object 210 when determining if the object 210 should be an object of interest.

FIG. 5 illustrates an overhead schematic view 400 of an area surrounding the vehicle 20 similar to FIG. 4. As shown in FIG. 5, the method 100 can identify a region of interest 212 that includes multiple objects 210. In one example, the objects 210 inside the region of interest 212 are each within a predetermined distance from an adjacent one of the objects 210. In another example, the region of interest 212 can include a group of objects with similar operating characteristics, such as traveling in a common direction that intersects the heading 202 of the vehicle 20. Because a region of interest 212 was identified, the image corresponding to this view is included in the subset of images and the objects 210 within the region of interest 212. This allows sections of the images with objects 210 to be ignored when performing the additional data labeling which reduces the labor needed for labeling. Alternatively, the entire image can receive the additional data labeling.

In one example, the region of interest 212 can be selected if the projection of the eye-gaze direction 206 intersects any of the objects 210 grouped together as discussed above. In another example, the region of interest 212 can be selected if the projection of the eye-gaze direction 206 extends within the predetermined angular range of the one or more of the detected objects 210 grouped together as discussed above.

Furthermore, the method 100 can exclude objects of interest or regions of interest 212 that are within a predetermined lateral distance of the heading 202 or within a predetermined range of projections of the eye-gaze direction 206 relative to or offset from the heading 202. The method 100 can exclude these images because the eye-gaze direction 206 of the operator of the vehicle 20 will generally reside in this area even if there are not any rare or unique scenes occurring. The method 100 can also exclude images from the subset of images if the vehicle 20 is parked or not moving for a predetermined length of time. Also, images from the image dataset can be excluded if the eye-gaze information indicates that the operator is interacting with internal controls on the vehicle 20, such as an infotainment system. The method 100 can also identify objects of interest that include a speed within a predetermined range, such as greater than 20 MPH (32 KPH).

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A method of analyzing an image dataset, the method comprising:
obtaining a dataset having a plurality of images of an area surrounding a vehicle;
identifying at least one object in each image of the plurality of images;
obtaining eye-gaze information directed to an operator of the vehicle from an eye-gaze monitoring system, wherein the eye-gaze information includes an eye-gaze direction of the operator corresponding to each of the plurality of images; and
identifying a subset of images from the plurality of images for performing additional data labeling based on a relationship between the eye-gaze direction and a position of the at least one object identified in each image of the plurality of images.

2. The method of claim 1, wherein the plurality of images are obtained from at least one optical sensor on the vehicle when the vehicle is operated in a non-autonomous mode.

3. The method of claim 1, wherein the relationship between the eye-gaze direction and the position of the at least one object is based on a proximity of a projection of the eye-gaze direction relative to the position of the at least one object.

4. The method of claim 3, wherein a selected image from the plurality of images is included in the subset of images by determining if the proximity of the projection of the eye-gaze direction relative to the position of the at least one object includes the projection of the eye-gaze direction intersecting the at least one object.

5. The method of claim 3, wherein a selected image from the plurality of images is included in the subset of images by determining if the proximity of the projection of the eye-gaze direction relative to the position of the at least one object is within a predetermined range.

6. The method of claim 5, wherein determining if the proximity of the projection of the eye-gaze direction relative to the position of the at least one object is within a predetermined range includes determining if the projection of the eye-gaze direction is within a predetermined angular range of the at least one object.

7. The method of claim 5, wherein the at least one object includes a plurality of objects and a selected image from the plurality of images is included in the subset of images by determining if the projection of the eye-gaze direction intersects at least one of the plurality of objects.

8. The method of claim 5, wherein the at least one object includes a plurality of objects and a selected image from the plurality of images is included in the subset of images by determining if the projection of the eye-gaze direction is within a predetermined angular range of at least one of the plurality of objects.

9. The method of claim 5, wherein determining if the proximity of the projection of the eye-gaze direction relative to the position of the at least one object is within the predetermined range includes determining if the projection of the eye-gaze direction intersected the at least one object for a predetermined length of time.

10. The method of claim 5, wherein determining if the proximity of the projection of the eye-gaze direction relative to the position of the at least one object is within the predetermined range includes determining a frequency that the projection of the eye-gaze direction intersected the at least one object.

11. The method of claim 1, wherein the at least one object is offset by a predetermined angular range from a heading of the vehicle and the at least one object includes a speed within a predetermined range.

12. The method of claim 1, wherein the at least one object in the subset of images includes a heading in a direction transverse to a heading of the vehicle.

13. A non-transitory computer-readable storage medium embodying programmed instructions which, when executed by a processor, are operable for performing a method comprising:
obtaining a dataset having a plurality of images of an area surrounding a vehicle;
identifying at least one object in each image of the plurality of images;
obtaining eye-gaze information directed to an operator of the vehicle from an eye-gaze monitoring system, wherein the eye-gaze information includes an eye-gaze direction of the operator corresponding to each of the plurality of images; and
identifying a subset of images from the plurality of images for performing additional data labeling based on a relationship between the eye-gaze direction and a position of the at least one object identified in each image of the plurality of images.

14. The method of claim 13, wherein the relationship between the eye-gaze direction and the position of the at least one object is based on a proximity of a projection of the eye-gaze direction relative to the at least one object.

15. The method of claim 14, wherein a selected image from the plurality of images is included in the subset of images by determining if the proximity of the projection of the eye-gaze direction relative to the position of the at least one object includes the projection of the eye-gaze direction intersecting the at least one object.

16. The method of claim 14, wherein a selected image from the plurality of images is included in the subset of images by determining if the proximity of the projection of the eye-gaze direction relative to the position of the at least one object is within a predetermined range.

17. The method of claim 16, wherein determining if the proximity of the projection of the eye-gaze direction relative to the position of the at least one object is within a predetermined range includes determining if the projection of the eye-gaze direction is within a predetermined angular range of the at least one object.

18. The method of claim 16, wherein the at least one object includes a plurality of objects and a selected image from the plurality of images is included in the subset of images by determining if the projection of the eye-gaze direction intersects at least one of the plurality of objects.

19. A vehicle system comprising:
at least one optical sensor configured to capture a plurality of images;
at least one distance sensor configured to measure a plurality of distances from the at least one distance sensor;
an eye-gaze monitoring system configured to determine a gaze direction of a driver; and
a controller in communication with the at least one optical sensor, the at least one distance sensor, and the eye-gaze monitoring system, wherein the controller is configured to:
obtain a dataset having a plurality of images of an area surrounding a vehicle;
identify at least one object in each image of the plurality of images;
obtain eye-gaze information directed to an operator of the vehicle from an eye-gaze monitoring system, wherein the eye-gaze information includes an eye-gaze direction of the operator corresponding to each of the plurality of images; and
identify a subset of images from the plurality of images for performing additional data labeling based on a relationship of the eye-gaze direction and a position of the at least one object identified in each image of the plurality of images.

20. The vehicle system of claim 19, wherein the relationship between the eye-gaze direction to the at least one object is based on a proximity of a projection of the eye-gaze direction relative to the position of the at least one object.
